(19) United States
(12) Patent Application Publication
(10) Pub. No.: US 2022/0332543 A1
(43) Pub. Date: Oct. 20, 2022

(54) ELEVATOR SYSTEM

(71) Applicant: Otis Elevator Company, Farmington, CT (US)

(72) Inventors: Wei Wang, Shanghai (CN); Zhenyan Tong, Shanghai (CN)

(21) Appl. No.: 17/528,430

(22) Filed: Nov. 17, 2021

(30) Foreign Application Priority Data
Apr. 15, 2021 (CN) 202110405692.8

(51) Int. Cl. B66B 7/02; B66B 7/10; B66B 7/04

(52) U.S. Cl. CPC B66B 7/023; B66B 7/10; B66B 7/047

(57) ABSTRACT

An elevator system includes guide rails located in an elevator hoistway and a running device adapted to reciprocate along the guide rails, and the guide rails are tensioned guide ropes.

### FOREIGN PRIORITY

This application claims priority to Chinese Patent Application No. 202110405692.8, filed Apr. 15, 2021, and all the benefits accruing therefrom under 35 U.S.C. § 119, the contents of which in its entirety are herein incorporated by reference.

### TECHNICAL FIELD

The present disclosure relates to the technical field of elevators; specifically, the present disclosure relates to an elevator system with guide rails.

### BACKGROUND

With social development, more and more multi-storey buildings and even high-rise buildings are arising in either living areas or in commercial and production areas. Elevators are usually installed in these buildings to transport people or goods between floors.

Generally speaking, an elevator system includes a car and a counterweight, and the car and the counterweight move up and down in an elevator hoistway along a T-shaped guide rail of a guiding system. The guiding system is mainly composed of guide rails, guide shoes and a guide rail frame, etc.

### SUMMARY

An object of the present disclosure is to provide an improved elevator system.

In order to achieve the above object, the present disclosure provides an elevator system, in which the elevator system includes guide rails located in an elevator hoistway and a running device adapted to reciprocate along the guide rails, and the guide rails are tensioned guide ropes.

Optionally, in the elevator system as described above, the running device is a car and/or a counterweight.

Optionally, in the elevator system as described above, a running direction of the running device is a vertical direction or has an inclination angle of smaller than 15 degrees relative to the vertical direction.

Optionally, in the elevator system as described above, the guide ropes are steel wire ropes or carbon fiber ropes.

Optionally, in the elevator system as described above, the guide ropes have a diameter between 10 mm and 30 mm.

Optionally, in the elevator system as described above, a top end of the guide rope is connected to a top wall of the hoistway through a first end-connection device, a bottom end of the guide rope is connected to a pit of the hoistway through a second end-connection device, and at least one of the first end-connection device and the second end-connection device is an end-connection device capable of adjusting a tensioning degree of the guide rope.

Optionally, in the elevator system as described above, the end-connection device capable of adjusting the tensioning degree of the guide rope is a rope fastening connected to the pit, and the rope fastening tightens the guide rope through a spring or a hydraulic device.

Optionally, in the elevator system as described above, guide shoes are installed at the running device, guide portions of the guide shoes have guide holes, and the guide holes are sleeved over the guide ropes.

Optionally, in the elevator system as described above, the guide portion of the guide shoe has two semicircular halves, and the two semicircular halves are spliced to form the guide hole.

Optionally, in the elevator system as described above, the two semicircular halves each have a shoe liner, and after the two semicircular halves are spliced, the shoe liner is located at an inner circumference of the guide hole.

### BRIEF DESCRIPTION OF THE DRAWINGS

With reference to the drawings, the content of the present disclosure will become more apparent. It should be understood that these drawings are only for illustrative purpose, and are not intended to limit the scope of protection of the present disclosure. In the drawings:

FIG. 1 is a schematic view of an elevator system according to an embodiment of the present disclosure;

FIG. 2 schematically shows a partially enlarged view of a part of a guide shoe encircled by A in the elevator system of FIG. 1; and

FIG. 3 is a schematic perspective view of the guide shoe in FIG. 2.

### DETAILED DESCRIPTION OF THE EMBODIMENT(S)

Specific embodiments of the present disclosure will be described in detail below with reference to the accompanying drawings. In the drawings, identical reference signs indicate identical or corresponding technical features. In addition, for the sake of brevity, for a technical feature provided in plural, only one or several places may be marked in the same drawing.

It can be understood that although a limited number of embodiments have been described in this specification, those skilled in the art can expand, modify, replace and/or combine technical features on this basis. Therefore, the content in this specification is descriptive and should not be regarded as limiting the scope of the present disclosure.

An elevator system can serve between floors of different heights, and a car thereof runs on a track perpendicular to the horizontal plane or having an inclination angle of smaller than 15 degrees relative to the plumb line. The elevator system may include a traction system, a guiding system, and so on. For example, the main function of the traction system includes outputting and transmitting power to make the elevator run; and the main function of the guiding system includes limiting the degree of freedom of movements of the car and a counterweight, so that the car and the counterweight can only move up and down along guide rails.

According to the present disclosure, in an embodiment of the elevator system, tensioned guide ropes are used to replace a rigid T-shaped guide rail commonly used in the elevator guiding system. The guide ropes extend in a hoistway of the elevator system along a running direction of the car, and an extending direction thereof may be a vertical direction or a direction slightly inclined relative to the vertical direction. With the elevator system arranged in this way, the installation time can be significantly shortened. Such elevator system may be an elevator in a low-storey building, an elevator in a high-storey building, a modular elevator system, or other types of elevator systems. In specific implementation, the guide ropes may be of the same rope material as traction ropes of the elevator system, and the diameter of the guide ropes may be selected according to specific requirements. Similarly, for the counterweight and other running devices that reciprocate along the guide rails in the elevator system, tensioned guide ropes may also be used as the guide rails.

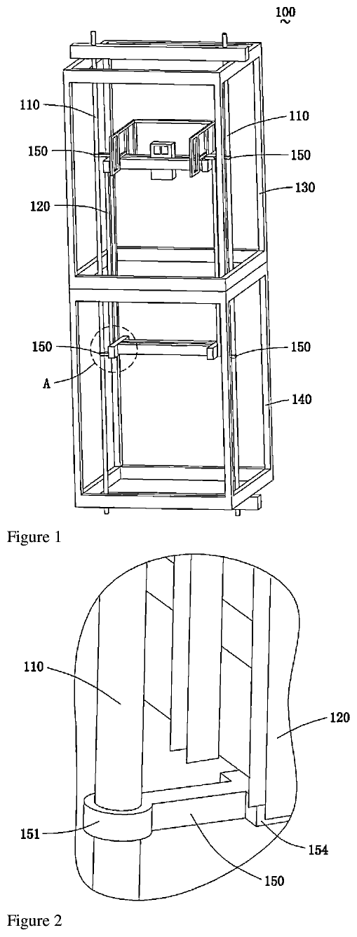

FIG. 1 is a schematic view of an elevator system according to an embodiment of the present disclosure.

As shown in the figure, the elevator system 100 includes guide rails in the form of guide ropes 110, and each guide rail is a guide rope 110. In the figure, two guide rails made of two guide ropes 110 are both used to guide the elevator car (not shown). The elevator car may be fixedly assembled in a car frame 120. As the car frame 120 reciprocates up and down along the guide ropes 110, the car can reciprocate up and down between different floors.

In the illustrated example, the car frame 120 of the elevator system is located between the two guide ropes 110. When the guide ropes themselves have sufficient tensioning forces, they can provide the rigidity required to guide the car and ensure a moving trajectory of the car. Even if there is an eccentric load in the car, the car will not tilt.

The guide ropes 110 may extend in the hoistway of the elevator system 100 along the running direction of the car. In the illustrated example, the guide ropes 110 extend vertically in the modular hoistway. It should be noted here that although the hoistway shown in FIG. 1 is illustrated as modular and consists of several hoistway modules 130, 140, etc., the guide rails in the form of guide ropes may also be applied to any elevator system having a traditional hoistway rather than a non-modular hoistway.

In the illustrated embodiment, the running direction of the car frame 120 and the car is consistent with the extending direction of the hoistway and is vertical, that is, the extending direction of the guide ropes 110 is vertical. In an alternative embodiment, the running direction may have a certain inclination angle relative to the vertical direction, e.g., an inclination angle of smaller than 15 degrees. As mentioned above, according to specific requirements, the extending direction of the guide ropes 110 may be perpendicular to the horizontal plane or have an inclination angle of smaller than 15 degrees relative to the plumb line, so as to achieve different elevator transportation requirements by defining the running direction of the car.

As mentioned above, in order to guide the car or the counterweight, the guide ropes 110 need to be tightened to achieve the rigidity required to guide the car or the counterweight.

The tensioning degree of the guide ropes may be adjusted according to the weight of the car. The larger the weight of the car is, the greater the required tensioning force will be. By tightening the guide ropes tightly enough, the deformation of the guide ropes can be limited to a small range when there is an eccentric load in the car, that is, when the weight of the car is not centered, so that the car will not tilt. On the other hand, the adjustment of the tensioning degree of the guide ropes may also take a lifting height of the elevator into consideration. The higher the lifting height of the elevator and the longer the guide ropes are, the greater the required tightening force will be. In addition, the adjustment of the tensioning degree of the guide ropes also needs to take a material thereof into consideration.

According to different application requirements, the guide ropes may have a diameter between 10 mm and 30 mm, but the diameter is not limited to this range. For example, when the lifting height of the elevator system is low, for example, when the lifting height is 20 m to 30 m and the carried load is 600 kg to 800 kg, steel wire ropes or carbon fiber ropes with a diameter of 12 mm may be selected. If the diameter of the guide ropes is increased, such as to 16 mm to 25 mm, a larger load bearing range can be covered, and the lifting height may also be expanded higher.

In the illustrated embodiment, the guide ropes 110 may be steel wire ropes; for example, they may be the same steel wire ropes as the traction ropes of the elevator system. The material, cross-section, and structure of the steel wire ropes may each be similar to or the same as the traction ropes used in the elevator system. For example, they may be of a round strand structure, and may be composed of steel wires, rope strands, and rope cores. The steel wires may be basic components of the steel wire ropes, and have appropriate strength and toughness. The rope strands may be twisted by several steel wires. The rope core may be a flexible core rod wrapped by the rope strands, and is typically made of a fiber material, thus playing the role of supporting and fixing the ropes and being capable of store lubricating oil.

The steel wire ropes used as the guide ropes 110 may be the same steel wire ropes as the traction ropes of the current elevator system. Alternatively, the steel wire ropes used as the guide ropes 110 may also be the steel wire ropes used as the traction ropes in the traditional elevator system, and are not necessarily the same steel wire ropes as the traction ropes of the current elevator system.

According to specific applications, carbon fiber ropes may be used as the guide ropes in some embodiments. In the case of using carbon fiber ropes, after they are tightened, they can provide greater rigidity and can better guide the elevator car and/or the counterweight.

In some specific embodiments, a top end of the guide rope 110 may be connected to a top wall of the hoistway through a first end-connection device, and a bottom end of the guide rope may be connected to a pit of the hoistway through a second end-connection device. In order to adjust the tensioning degree of the guide rope, at least one of the first end-connection device and the second end-connection device is an end-connection device capable of adjusting the tensioning degree of the guide rope. The end-connection device may include a spring or a hydraulic device (such as but not limited to a jack) to provide a tensioning force and to tighten the guide rope.

For example, as an example, the end-connection device capable of adjusting the tensioning degree of the guide rope may be a rope fastening commonly used at an end of the traction ropes of the traction system, which may be a standard component for fixing the traction ropes.

One end of the guide rope 110 may be not adjustable. For example, at this end, the fixing of the guide rope can be achieved by nailing the end of the rope by a rivet bolt or a pre-buried hook, etc. This end may be the top end of the guide rope, in which case the hook may be pre-buried on the top of the hoistway or on a crossbeam at the top of the hoistway; or this end may be the bottom end of the guide rope, in which case the hook may be pre-buried at the pit of the hoistway or on a crossbeam at the pit. The crossbeam can be used to distribute the received force to various load-bearing positions of the building. The adjustable end can be tightened by a spring or a hydraulic device (such as but not limited to a jack).

Considering that the guide rope will be slowly stretched during use, it will be necessarily required to adjust the tensioning degree of the guide rope after a period of use. Therefore, it is advantageous to arrange the adjustable rope fastening at the bottom end of the guide rope, which makes it more convenient for maintenance personnel to perform adjustment operations. In an alternative embodiment, the bottom end can also be simply tightened by a spring or a hydraulic device (such as but not limited to a jack). If the guide rope is stretched, the tension of the spring can be adjusted by the bolt of the rope fastening at the bottom end or the pit, and the spring can then tighten the guide rope.

In FIG. 1, the description is given in respect to the guide rope 110 of the elevator car. Based on this description, those skilled in the art can make similar or identical settings to the guide rail of the counterweight of the elevator system according to the present disclosure, that is, the guide rail of the counterweight of the elevator system may also be a tensioned guide rope. Correspondingly, the tensioned guide rope extends in the hoistway of the elevator system along the running direction of the counterweight. The running direction of the counterweight may be consistent with the running direction of the elevator car. The end-connection method of the guide rope may also be the same as or similar to the end-connection method of the guide rope of the car.

In an alternative embodiment, both ends of the guide rope may also be arranged at the top or bottom end of the hoistway at the same time. The guide rope can be steered by a pulley and other devices.

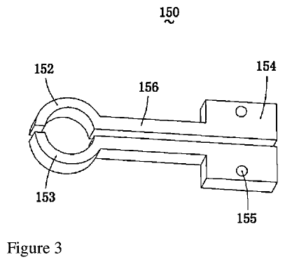

FIG. 2 schematically shows a partially enlarged view of a part of a guide shoe encircled by A in the elevator system of FIG. 1. FIG. 3 is a schematic perspective view of the guide shoe in FIG. 2.

It can be seen from FIG. 2 that a base of the guide shoe 150 is fixed to the car frame 120, and a guide portion 151 of the guide shoe 150 is composed of two halves 152 and 153 which form a guide hole. The guide rope 110 passes through the guide hole. The shape of the guide hole may match the shape of the guide rope 110. In the illustrated example, since the cross section of the guide rope 110 is circular, the guide hole of the guide shoe 150 is also circular. The traditional guide shoe may not be suitable here, because the traditional guide shoe matches the T-shaped guide rail and cannot be applied to the guide rope in the illustrated embodiment.

The base 154 of the guide shoe 150 may be fixed to the car frame 120 by common methods such as bolts and welding. Fixing holes 155 at the base of the guide shoe 150 are shown in FIG. 3. As shown in FIG. 1, a total of four guide shoes 150 are provided on the car frame, in which two upper and lower guide shoes are respectively provided on both sides of the car frame 120.

The guide ropes 110 guide the car frame and the car through the guide shoes 150. Specifically, the guide shoes 150 are fixed to the car frame 120 as described above, and when the car frame 120 reciprocates along the guide ropes 110, the car is driven to move up and down. The parking of the elevator car can be realized by a safety gear.

FIG. 3 shows the structure of the guide shoe more clearly. As can be seen from the figure, the guide shoe 150 includes two halves, and each guide shoe half includes a base 154, a semicircular guide half 152, 153, and a connecting portion 156 between the base 154 and the semicircular guide half 152, 153. When the guide shoe 150 is installed, the two halves are spliced together to form a guide shoe with a base 154 and a guide portion 151, and the guide portion is suitable for holding the guide rope through the guide hole. The base 154 can be used to be fixed to the car frame or the car, and the guide portion 151 is used to be sleeved over the guide rope. It can be seen from FIG. 3 that the guide portion 151 may include two opposite halves 152 and 153, and the two halves 152 and 153 are spliced together to form a guide hole. In order to prevent the interference with the up-and-down movement when the guide hole holds the guide rope, the additional guide rail bracket commonly used in the existing system can be eliminated.

In an alternative embodiment, the two halves 152, 153 may each have a replaceable shoe liner (not shown), and the shoe liner is provided at a position suitable for contact with the guide rope at the guide portion. When the two halves are spliced, the shoe liner is located at an inner circumference of the guide hole. The shoe liner may be made of a wear-resistant material. If the shoe liner is worn, the reliable guiding performance of the guide shoe can be quickly restored by replacing the shoe liner.

Through the above description in conjunction with the accompanying drawings, it can be understood that in an alternative embodiment of the present invention, the guide ropes are used to replace the T-shaped guide rail of the traditional elevator system. The T-shaped guide rail of the traditional elevator system need to be connected segment by segment during installation; however, since the guide ropes themselves can achieve a great tension, the elevator car and/or the counterweight can be guided by pulling the guide ropes from the top end to the pit of the hoistway of the elevator system, so that the car and/or the counterweight reciprocate along the guide ropes. By replacing the guide rails with the guide ropes, in one embodiment, the guide ropes can be tightened by a heavy object from the pit. The tension of the guide ropes can provide rigidity, and the moving trajectories of the car and counterweight can be ensured without additional guide rail brackets.

For traditional elevators, during installation and construction, the guide rails need to be hoisted and connected one by one, and then connected with the guide rail brackets. In this case, it takes up to 50% of the entire elevator installation time to install all the guide rails from top to bottom, which is very time-consuming. However, if the guide ropes are used, the installation by the guide rail brackets is omitted. After the top end of the guide rope is fixed, the guide rope is tightened at the bottom, and then the guide rope is adjusted to a proper tensioning degree so that the installation of the guide rail is completed, which greatly shortens the elevator installation time.

For installation of the existing elevator, the lowermost two segments of the guide rail are installed first at the pit, then the car frame (i.e., the car) is placed in the hoistway so as to be supported in place first, and then the car is installed. According to the illustrated embodiment, when installing the car, after the guide rope is installed first, the car is placed in an appropriate position, and then the guide rope is inserted through the guide hole of the guide shoe. In terms of the installation sequence, the guide rail in the form of the guide rope can be the same as the traditional guide rail, but the use of the guide rope reduces the installation time of the guide rail itself greatly. The fixing of the two ends of the guide rope can also eliminate the use of additional special devices, and it can be simply realized by only fixing the top end and tightening the bottom end using the rope fastening.

As to the top end of the guide rope, according to the strength of the building at the top machine room of the elevator hoistway, if the building itself is strong enough, the top end of the guide rope can be nailed to the ground of the machine room, and if the building is not strong enough, a crossbeam may be additionally provided, and then the top end of the guide rope is nailed to the cross beam. Since the tension of the guide rope is relatively large when the guide rope itself is tightened very tightly, it is necessary to ensure sufficient structural strength. The crossbeam can distribute the tension to different positions of the building.

As mentioned earlier, an elevator system according to several embodiments of the present disclosure is described in the specification. It should be understood that the scope claimed by the present disclosure is not only limited to the content described above. Without departing from the technical idea of the present disclosure, those skilled in the art can make various expansions, modifications, substitutions and/or combinations to the above-mentioned embodiments, and these expansions, modifications, substitutions and/or combinations should all be considered as falling within the scope claimed by the present disclosure.

What is claimed is:

1. An elevator system, comprising guide rails located in an elevator hoistway and a running device adapted to reciprocate along the guide rails,
wherein the guide rails are tensioned guide ropes.

2. The elevator system according to claim 1, wherein the running device is a car and/or a counterweight.

3. The elevator system according to claim 1, wherein a running direction of the running device is a vertical direction or has an inclination angle of smaller than 15 degrees relative to the vertical direction.

4. The elevator system according to claim 1, wherein the guide ropes are steel wire ropes or carbon fiber ropes.

5. The elevator system according to claim 1, wherein the guide ropes have a diameter between 10 mm and 30 mm.

6. The elevator system according to claim 1, wherein a top end of the guide rope is connected to a top wall of the hoistway through a first end-connection device, a bottom end of the guide rope is connected to a pit of the hoistway through a second end-connection device, and at least one of the first end-connection device and the second end-connection device is an end-connection device capable of adjusting a tensioning degree of the guide rope.

7. The elevator system according to claim 6, wherein the end-connection device capable of adjusting the tensioning degree of the guide rope is a rope fastening connected to the pit, and the rope fastening tightens the guide rope through a spring or a hydraulic device.

8. The elevator system according to claim 1, wherein guide shoes are installed at the running device, guide portions of the guide shoes have guide holes, and the guide holes are sleeved over the guide ropes.

9. The elevator system according to claim 8, wherein the guide portion of the guide shoe has two semicircular halves, and the two semicircular halves are spliced to form the guide hole.

10. The elevator system according to claim 9, wherein the two semicircular halves each have a shoe liner, and after the two semicircular halves are spliced, the shoe liner is located at an inner circumference of the guide hole.
